(19) United States
(12) Patent Application Publication
(10) Pub. No.: US 2016/0325380 A1
(43) Pub. Date: Nov. 10, 2016

(54) HYBRID MANUFACTURING USING METAL FORMING AND ADDITIVE MANUFACTURING

(71) Applicant: DM3D TECHNOLOGY, LLC, AUBURN HILLS, MI (US)

(72) Inventors: BHASKAR DUTTA, TROY, MI (US); MARK DAVID LEWAN, WHITE LAKE, MI (US)

(21) Appl. No.: 15/147,504

(22) Filed: May 5, 2016

Related U.S. Application Data
(60) Provisional application No. 62/158,762, filed on May 8, 2015.

(51) Int. Cl. B23K 26/342; B23K 26/144

(52) U.S. Cl. CPC B23K 26/342; B23K 26/144; B33Y 10/00

(57) ABSTRACT

A method of forming a three dimensional component includes predetermining a geometric configuration of the component. A first portion of the component is preformed from a first material by one of casting, forging, stamping, roll forming, extruding or molding. A second portion of the component is including a second material is deposited onto the first portion of the component using direct material deposition for reconfiguring the first portion to the predetermined geometric configuration of the component. The physical characteristics of the component are enhanced with the second portion providing a geometric configuration to the component not provided by preforming the first portion.

### PREVIOUS APPLICATIONS

The present application claims priority to U.S. patent application Ser. No. 62/158,762 filed May 8, 2015, the contents of which are included herein by reference.

### TECHNICAL FIELD

The present invention relates to an improved method of manufacturing large three dimensional components. More particularly, the present invention relates generally toward a method of manufacturing combining direct material deposition with metal forming to provide more efficient manufacturing processes.

### BACKGROUND

Manufacturing large mechanical components has always proven difficult, particularly when various three dimensional elements are required of a particular component. Previously, only casting could provide three dimensional elements of a large component. Casting complex three dimensional elements is slow and cost prohibitive often requiring complex dies known to be expensive. It would be preferable to stamp, roll form or extrude a large three dimensional component to achieve mass reduction and efficiency savings. However, it has not been feasible to form three dimensional elements upon a component formed from sheet metal without performing complex welding to attach these elements to a component. Even exceedingly expensive progressive dies have limitations preventing their use in many applications

One method of forming a complex three dimensional component with the use of direct material deposition or 3D printing techniques. However, 3D printing large components, based on volume of printing required has also proven inefficient and cost prohibitive limiting broader acceptance as a viable manufacturing alternative for large and complex objects.

Therefore, it would be desirable to develop a method of forming a three dimensional component, including the three dimensional elements required of that component in a rapid, cost efficient manner.

### SUMMARY

A method of forming a three dimensional component includes first predetermining a geometric configuration of the component. A first portion of the component is preformed and includes a first material. The first portion is preformed by one of casting, forging, stamping, roll forming, extruding, or molding. A second portion of the component includes a second material that is deposited upon the first portion of the component using direct material deposition process. In this manner, the first portion is reconfigured to the predetermined geometric configuration of the component. The physical characteristics of the component are enhanced by the second portion providing a geometric configuration to the component not possible of preforming the first portion using conventional forming techniques.

A novel approach for manufacturing a three dimensional component of the present application combines the best features of conventional metal forming with the advanced techniques of direct material deposition. The difficulties associated with attempting to cast or form three dimensional elements of a three dimensional component are overcome by first preforming a portion of the component and second performing direct material deposition to achieve advanced three dimensional shape of the component. As such, complex, large three dimensional components can now be manufactured in an efficient, cost effective manner.

### BRIEF DESCRIPTION OF THE DRAWINGS

Other advantages of the present invention will be readily appreciated as the same becomes better understood by reference to the following detailed description when considered in connection with the accompanying drawings, wherein:

FIG. 1 shows a nozzle performing direct material deposition upon a plate;

FIG. 2 shows a cross-sectional view of the three dimensional component shown in FIG. 1;

FIG. 3 shows a bottom view of an alternate component having direct material deposition features;

FIG. 4 shows an opposite side of the component represented in FIG. 3;

FIGS. 5a and 5b show direct material deposition material process of the component shown in FIGS. 3 and 4;

FIG. 5c shows a cross-sectional view of the component shown in FIGS. 3 and 4 having a plurality of layers of direct material deposition formed thereon;

FIG. 6a shows laser welding being performed upon a seam of a tubular preform;

FIG. 6b shows direct material deposition being performed upon the tubular member; and

FIG. 6c shows a tubular component formed from the process shown in FIGS. 6a and 6b.

### DETAILED DESCRIPTION

The invention of the present application provides a method for improved manufacturing of large three dimensional components by combining with the advances associated with 3D printing and additive manufacturing with conventional metal forming processes. As such, metal forming processes included, but not limited to, casting, forging, rolling, roll forming, stamping, hot forming, are all included within the scope of this application.

The combination of conventional manufacturing processes with direct material deposition provides the ability to advance quality of the ensuing products. Direct material deposition processes disclosed in U.S. Pat. No. 6,925,346 which discloses closed-loop, rapid manufacturing of three-dimensional components using direct metal deposition, and U.S. Pat. No. 8,878,094 covering part-geometry independent real time closed loop weld pool temperature control system for multi-layer DMD process are contemplated for use in the method of the present application, and the contents of these patents are incorporated herein by reference.

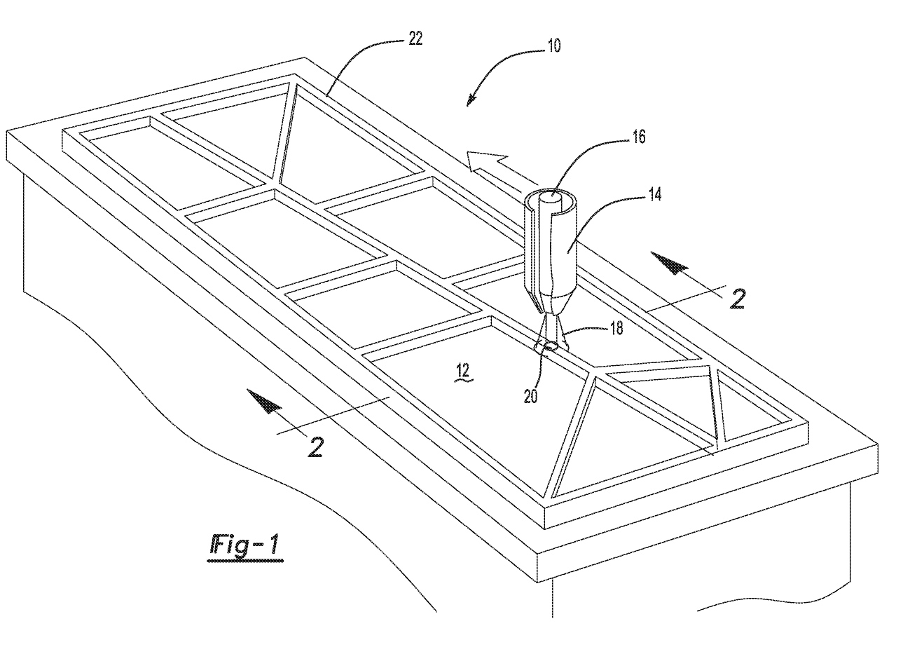

The first embodiment of the present invention is shown in FIG. 1 generally at 10. In this embodiment, sheet metal 12 in the form of a flat plate is provided from a blank cut from rolled stock. A nozzle 14 is affixed to an articulating member (not shown) to direct a laser 16 along a predetermined path above the sheet metal 12. The nozzle 14 delivers powdered material 18 into a melt pool 20 generated by the laser 16 upon the sheet metal 12. In this manner, ribs 22 or other structural features are deposited onto the flat sheet metal 12 to provide structural support to the sheet metal 12.

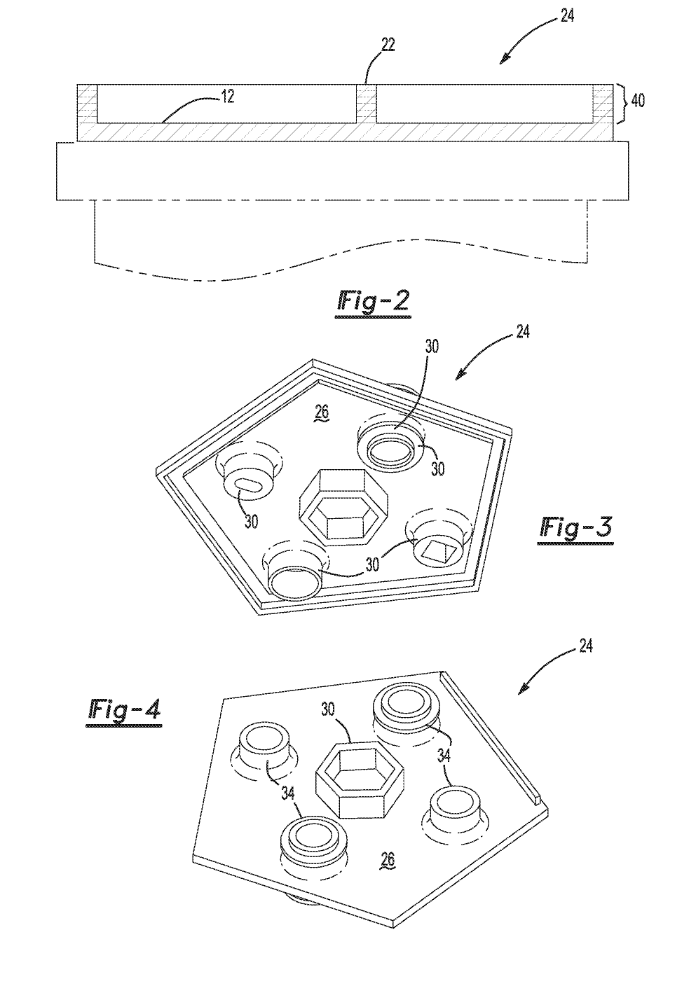

Referring now to FIG. 2, which shows a cross-sectional view through line 22 of FIG. 1, a plurality of layers 24 are deposited by the nozzle 14 in a known manner. Therefore, it should be understood by those of ordinary skill in the art that the nozzle 14 continues along a predetermined path to generate a desired three dimensional configuration of the ribs 22 to provide the desired geometric configuration.

In this embodiment, the sheet metal blank defines a first portion 26 of the desired component 10 including a first material and the direct metal deposition provides a second portion of the desired component 10 from a second material. The second material, in one embodiment, is substantially the same as or identical to the first material. Alternatively, the second material is different than the first material to provide further enhancements to the physical characteristics and material properties of the component 10 when the predetermined geometric configuration is developed by the direct material deposition of the second material.

For example, the first material is selected from a light weight or low cost alloy to achieve either mass or cost objectives. The second material is selected to provide different material characteristics from an alloy that would be cost prohibitive to form the entire component from. Thus, the method of the present invention provides the ability to optimize both performance and cost of a component. Further, the second material can be selected from an alloy or an alloy enhanced with ceramics or other materials to further improve the physical characteristics and material properties of the component by way of direct material deposition.

FIG. 3 shows a further embodiment of the component generally at 24. In this embodiment, the first portion 26 formed from one of casting, forging, stamping, roll forming, extrusion, or molding. The second portion 28 formed by way of direct material deposition provides features not possible of any of the methods used to form the first portion 26. For example, forming a plurality of bosses 30 having unique configurations, and even configuration known to cause a die lock preventing forming by conventional means is now achievable. Additionally, a flange 32 may also be formed by way of direct material deposition providing further enhanced physical characteristics to the component 24. As set forth above, the first portion 26 is formed from a first material and the second portion 28 is formed from a second material. The first material and a second material, in one embodiment, is substantially the same material. Alternatively, to achieve further enhanced physical characteristics to the component 24 a second material is different from the first material as set forth above.

FIG. 4 shows an opposite side of the component 24 shown in FIG. 3. A plurality of alternative bosses 34 are formed by way of direct material deposition. Therefore, further additional complexity is achievable of a component not previously achievable through conventional forming techniques.

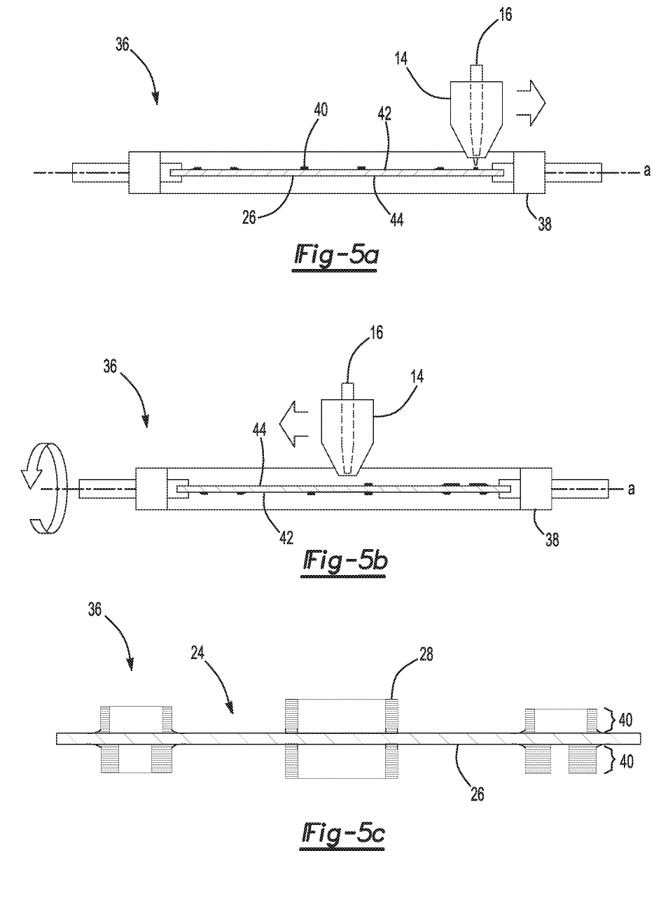

A method of forming the component 24 of the further embodiment is generally shown at 36 of FIGS. 5a through 5c. The first portion 26 of the further embodiment is mounted in a fixture 38 that pivots around axis a. The nozzle 14 deposits a first layer 40 of second material to begin forming the first portion 26 of the component 24 of the further embodiment. In one embodiment, the bosses 30 are completely formed upon a first side 42 of the first portion 26. Subsequent to forming the first bosses 30, the fixture 38 pivots the first portion 26 around axis a and the nozzle 14 begins deposition of the second material upon a second side 44 of the first portion 26.

Alternatively, the nozzle 14 deposits the first layer of material 40 upon the first side 42 of the first portion 26 and the fixture 38 rotates the first portion 26 so that the nozzle 14 deposits a first layer of material upon the second side 44 of the first portion 26. In this manner, the first layer 40 deposited upon the first side 42 of the first portion 26 cools prior to receiving a second layer of the second material. As represented in FIG. 5c, a plurality of layers 40 form the second portion 28 to provide desired three dimensional geometric configuration to the component 24 of the further embodiment. It should be understood by those of skill in the art that the direct material deposition of the second portion 28 provides a geometric configuration close to that of a final geometric configuration. However, mechanical modification of the second portion 28 is generally performed. As recited in the claims, “predetermined configuration” includes a configuration close to that of a complete component. In some instances, it is desirable to mechanically alter the all of, or some of, the second portion 26 to achieve further dimensional accuracy.

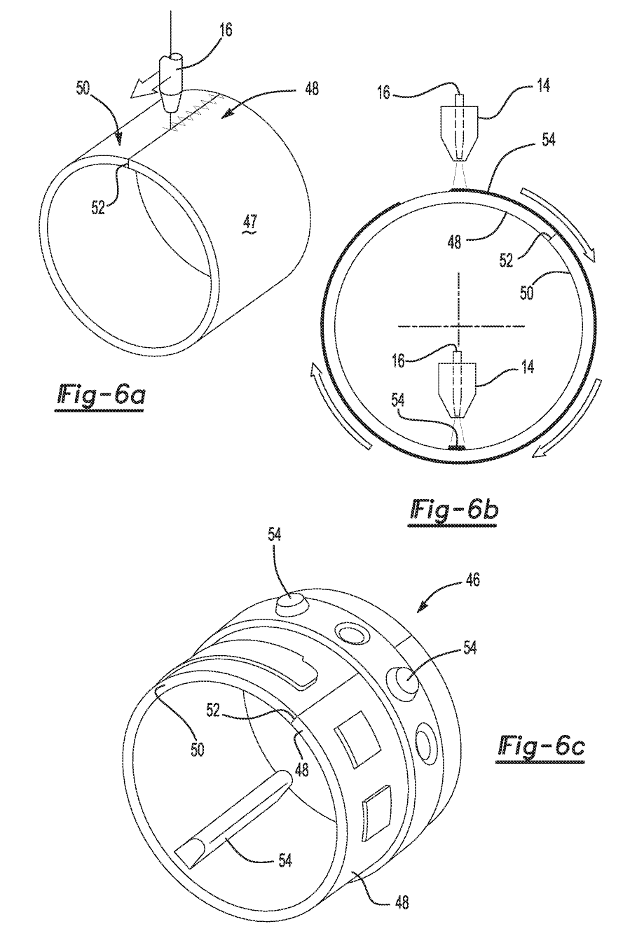

FIGS. 6a through 6c show a still further embodiment of the present invention. The component 46 of the instant embodiment 46 includes an alternative first portion 47 that defines a tubular member. The additional first portion 47 includes a first element 48 and a second element 50 that when abutting define a seam 52. The laser 16 is used to laser weld the seam 52 to attach the first element 48 to the second element 50. Alternatively, a different laser (not shown) may also be used to laser weld the seam 52.

In a similar manner as set forth above, a second portion 54 is deposited by the nozzle 14. The nozzle 14 moves along the additional first portion 47 providing material deposition of the second material over the first material defining the additional first portion 47. One or more nozzles 14 may be used to deposit the material defining the second portion 54 upon the additional first portion 47. Furthermore, simultaneous use of two nozzles 14 further increases the efficiency when forming the component 46 of the additional embodiment. Still further, the second portion 54 may also be deposited upon an inner surface 56 of the first portion 47 if affixed to an articulating arm (not shown). In this manner, complex geometric configurations of the second portion 54 can be formed upon a roll formed or extruded first portion 47 that were not previously achievable. In addition, deposition of a third material is also within the scope of this invention to provide still further benefits to the component 46.

The invention has been described in an illustrative manner, and is to be understood that the terminology which has been used is intended to be in the nature of words of description rather than of limitation. It is now apparent to those skilled in the art that many modifications and variations of the present invention are possible in light of the above teachings. It is, therefore, to be understood that the invention may be practiced otherwise and is specifically described, and still be within the scope of the present application.

What is claimed is:

1. A method of forming a three dimensional component, comprising the steps of:
predetermining a geometric configuration of the component;
preforming a first portion of the component comprising a first material by one of casting, forging, stamping, roll forming, extruding or molding;
depositing a second portion of the component comprising a second material onto the first portion of the component using direct material deposition thereby reconfiguring the first portion to the predetermined geometric configuration of the component; and
enhancing the physical characteristics of the component with the second portion by said second portion providing a geometric configuration to the component not provided by preforming the first portion.

2. The method set forth in claim 1, wherein said step of depositing a second portion of the component comprising a second material is further defined by said second material being different than said first material.

3. The method set forth in claim 1, wherein said step of depositing a second portion of the component comprising a second material is further defined by said second material being substantially the same as said first material.

4. The method set forth in claim 1, wherein said step of preforming a first portion of the component is further defined by preforming first and second elements of the component.

5. The method set forth in claim 4, further including a step of laser welding said first element to said second element.

6. The method set forth in claim 5, wherein said step of laser welding said first element to said second element is further defined by joining said first element to said second element with said second material.

7. The method set forth in claim 1, wherein said step of preforming a first portion of the component is further defined by preforming a first side and a second side of the first portion and said step of depositing a second portion of the component is further defined by depositing said second portion onto said first side and said second side of said first portion.

8. The method set forth in claim 7, wherein said step of depositing said second portion onto said first side and said second side of said first portion is further defined by intermittently depositing said second portion onto said first side and said second side of said first portion.

9. The method set forth in claim 8, wherein said step of intermittently depositing said second portion onto said first side and said second side of said first portion is further defined by intermittently depositing a plurality of layers on said first side and said second side of said first portion.

10. The method set forth in claim 1, further including a step of mechanically modifying said second portion of said component to said predetermined geometric configuration of said component.

11. The method set forth in claim 1, further including a step of mechanically modifying said first portion and said second portion of said component to said predetermined geometric configuration of said component.
